(19) United States
(12) Patent Application Publication
(10) Pub. No.: US 2005/0245235 A1
(43) Pub. Date: Nov. 3, 2005

(54) System and method for wireless network security

(76) Inventor: Sarosh Vesuna, Los Altos, CA (US)

Correspondence Address: Fay Kaplun & Marcin, LLP;Suite 702, 150 Broadway, New York, NY, 10038, US

(21) Appl. No.: 10/834,736

(22) Filed: Apr. 29, 2004

(51) Int. Cl. H04M 3/16

(52) U.S. Cl. 455/411

(57) ABSTRACT

Described are a system and method for a wireless network security. The system may include a wireless electronic device and a wireless access point. The access point includes a memory and is capable of wirelessly communicating with the device. The memory stores an access scheme which defines an authentication procedure for allowing the wireless communications between the electronic device and the further asset. The authentication procedure utilizes data as defined by the access scheme. The access point is situated in a location accessible to an authorized user and provides access for the electronic device to a further asset. The access point allows the wireless communications between the electronic device and the further asset only when the authentication procedure is successful. Before the authentication procedure, the data is transferred between the device and the access point via a physical access to at least one of the access point and the electronic device.

### BACKGROUND

A conventional wireless communication network may include a plurality of wireless electronic devices (“WED”) which communicate with other wireless devices or among themselves using a wireless communication protocol (e.g., IEEE 802.11). Examples of WEDs include laptop computers, PDAs, cell phones, Voice over IP (VOIP) phones, and two-way pagers. In the wireless network, the WEDs are capable of exchanging data and/or voice signals among each other and/or with an access point (“AP”) connected to a wired network using radio waves over dedicated frequencies or dedicated segments of the electromagnetic spectrum. The AP allows the WEDs to communicate with elements on the wired network (e.g., servers, telephones, fax machines) and vice versa. Thus, the AP may be a router or transceiver box that provides access for the WEDs to the wireless and wired networks.

The AP may be placed in a location that is accessible to a large number of WEDs (e.g., in a conference room, near employees' offices, etc.). Thus, when the AP transmits and receives radio waves from the WEDs, those waves may be subject to tampering by persons within a radio wave range. For example, a small office in a large multi-unit building may have its own AP, and therefore its own wireless network. However, someone in an adjacent unit may be within range of the radio wave transmissions from the AP. Thus, the AP in the office may be accessible by unauthorized persons located in the adjacent unit.

Unauthorized access in wireless networks has been addressed by the wireless communication protocols (e.g., wired equivalent privacy (“WEP”)) . For example, the WEP was intended to provide the same level of security in wired networks to wireless networks. However, the WEP was found to be not as secure as desired because encryption keys were openly transmitted (i.e., without any security) and the WEP is static. The WEP is only used on the data link and physical layers; it therefore does not provide end-to-end security.

### SUMMARY OF THE INVENTION

Described are a system and method for a wireless network security. The system may include a wireless electronic device and a wireless access point. The access point includes a memory and is capable of wirelessly communicating with the device. The memory stores an access scheme which defines an authentication procedure for allowing the wireless communications between the electronic device and the further asset. The authentication procedure utilizes data as defined by the access scheme. The access point is situated in a location accessible to an authorized user and provides access for the electronic device to a further asset.

The access point allows the wireless communications between the electronic device and the further asset only when the authentication procedure is successful. Before the authentication procedure, the data is transferred between the device and the access point via a physical access to at least one of the access point and the electronic device.

### BRIEF DESCRIPTION OF THE DRAWINGS

FIG. 1 shows an exemplary embodiment of a wireless network according to the present invention;

FIG. 2 shows an exemplary embodiment of a method according to the present invention; and

FIG. 3 shows an exemplary embodiment of an authentication method of the present invention.

### DETAILED DESCRIPTION

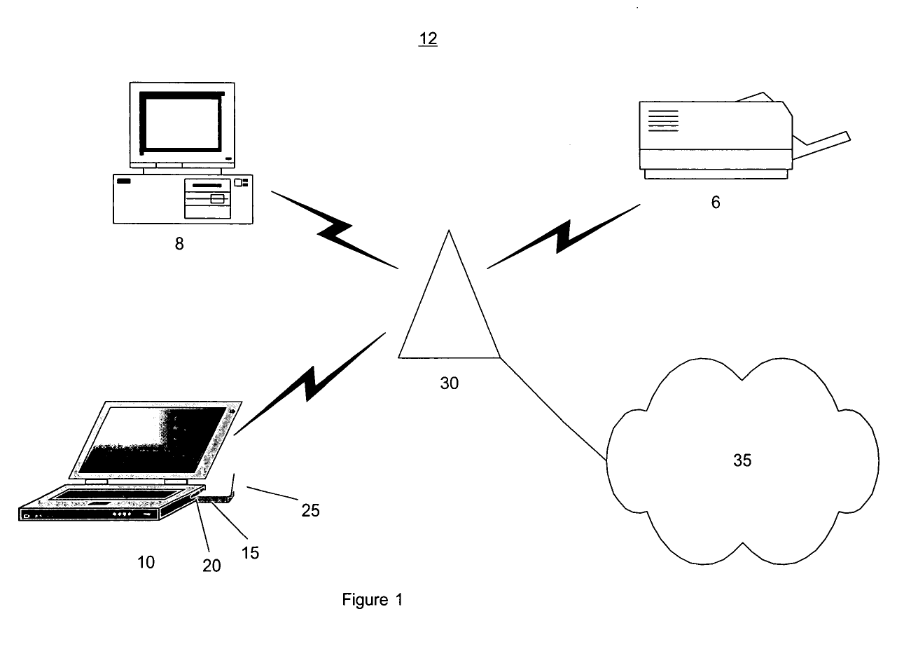

FIG. 1 shows an exemplary embodiment of a communication network 12 according to the present invention. The network 12 may include a wireless infrastructure and a data distribution system. For example, the network 12 includes a plurality of WEDs such as a desktop computer 8, a printer 6, a server, a mobile unit, a laptop 10, a PDA, a cell phone, a two-way pager, etc. These WEDs may include a wireless communication arrangement (“WCA”) and communicate using a conventional wireless communication protocol. The network 12 may also be connected to a further communication network 35 (e.g., an WAN, the Internet, a VLAN, etc.)

In one exemplary embodiment of the present invention, the WED may be the laptop 10 and the WCA is a wireless network card 15 which may be inserted into a PCMCIA slot 20 or permanently installed within the laptop 10. The network card 15 may include an antenna 25 in order to facilitate wireless communications.

The WEDs access the network 12 via an access point (“AP”) 30. The AP 30 may transmit and receive wireless communications to/from the WEDs or other assets of the network 12. As would be understood by those skilled in the art, the AP 30 may be a wireless router, transceiver or any other element that is capable of communicating, bridging and routing using the wireless communication protocol. A plurality of non-WEDs may also be directly connected to the AP 30 (e.g., a server, etc.).

The network 12 may be situated in a user's location such as a home, an office, etc. The AP 30 may be situated within the location and physically accessed by authorized users. Although, the AP 30 is physically located within the location controlled by the user, the wireless signals transmitted to/from the AP 30 may be accessed from another location outside of the user's location. For instance, a user's neighbor with a wireless computing device (not shown) may be able to wirelessly communicate with the AP 30, because the neighbor's computing device is located within a wireless communication range of the AP 30. Thus, the neighbor may access certain assets of the network 12 or obtain access to the further network 35.

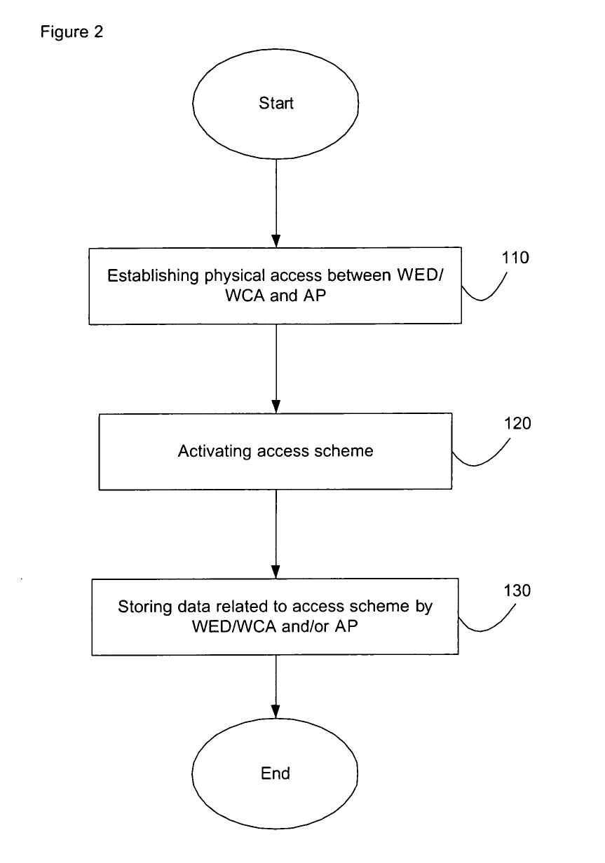

FIG. 2 shows an exemplary embodiment of a method according to the present invention for authentication and security of the network 12. In a preferred exemplary embodiment, the AP 30 is situated in a location which is physically accessible to the authorized user(s). As would be understood by those skilled in the art, a definition of a secure location is relative depending on the user and/or the location. For example, a bank may situate the AP 30 in a locked room accessible only by an IT staff, while a homeowner may situate the AP 30 in a home office, knowing that the house will be locked. Thus, the physical access to the AP 30 is available only to authorized users of the network 12.

In step 110, an authorized user establishes direct or indirect contact between the WED and the AP 30. In a preferred embodiment according to the present invention, the contact between the WED and the AP 30 is a direct and physical contact. Such a direct physical contact may be accomplished in several manners. In one embodiment, the WED (or the WCA) may be connected with the AP 30 using a wire that plugs into a communication port (e.g., USB, IEEE 1394, ethernet, serial port, etc.). As would be understood by those skilled in the art, the port may be located on the AP 30 or the WED.

In one exemplary embodiment according to the present invention, the AP 30 may include a slot configured to receive the WCA. For example, the contact is established by plugging the WCA into a standard slot of the AP 30 (not shown). In a further embodiment, the AP 30 may have a contact point or pad that receives a similar contact point or pad on the WCA. For example, the contact between the WCA and the AP 30 is established by touching the contact point/pad on the WCA to the contact point/pad on the AP 30. The contact point of the AP 30 may have a concave portion which receives a dimple or a convex portion on the WCA.

In a yet another exemplary embodiment of the present invention, the WED and the AP 30 may be indirectly contacted using, e.g., a portable memory card such as a compact flash. The portable memory card may be utilized as an intermediary to establish the contact between the WED and the AP 30. This particular embodiment may be useful in those situations where the WCA may not be easily removed from the WED. This embodiment may also be useful if the user wishes to authenticate several WEDs at one time without bringing each in contact with the AP 30.

Once the user has established contact between the WED and the AP 30, then an access scheme is activated (step 120). In particular, an authentication procedure is activated according to the access scheme. The access scheme may as a simple as having a unique identifier which is capable of uniquely identifying the WCA and/or the WED to the AP 30 or vice versa. In such case, the WED may upload the unique identifier to the AP 30 or vice versa.

In this manner, the identifier may be stored in the form of a barcode. Such a barcode may be read by the AP 30, or the AP 30 may have a barcode scanner. Furthermore, the unique identifier may be stored in an RFID tag and is capable of being read by the AP 30. Those skilled in the art would understand that the barcode and/or the RFID tag may be replaced/reprogrammed with a different unique identifier (i.e., if the same WCA is used to authenticate various WEDs). As would be understood by those skilled in the art, the identifier may be a serial number, a manufacturer identification number, a preprogrammed number, or any other characteristic and/or combination of these numbers that generates a uniquely identified number.

In an alternative exemplary embodiment of the present invention, the access scheme may include a predefined procedure which defines setting for the authentication procedure between the AP 30 and the WED. For example, the procedure may define data (e.g., a plurality of. random numbers which must be periodically exchanged in order to sustain the wireless communications) and define how the data is processed by the AP 30 and/or the WED. The procedure may also set a time limit on the wireless communication (e.g., the WED is allowed to communicate with the AP 30 for 30 minutes).

Once uploaded to or read by the AP 30 and/or the WED, the data (e.g., the unique identifier, the predefined procedure data) may be stored in a corresponding memory (step 130). For example, a database of authorized unique identifiers may be created and stored in the memory of the AP 30. Furthermore, the data may be encrypted when transmitted between the WED and the AP 30. The encryption system may be a conventional system, such as a PGP system.

In yet another alternative exemplary embodiment of the present invention, the AP 30 may include a portable input arrangement such as a keypad. The keypad allows the user to enter the data according to the access scheme into or remove the data from the AP's memory. This may eliminate the need for the contact between the WED and the AP 30. Furthermore, the portable input arrangement may be also attached to the AP 30 via a communication port (e.g., USB, ethernet, etc.). Those skilled in the art would understand that the WED may also be attached to the AP 30 to edit the data (e.g., add/delete the authorized unique identifiers) from the memory of the AP 30. For example, an authorized user may want to authenticate several WEDs by entering the data (e.g., a set of unique identifiers of the WEDs at once).

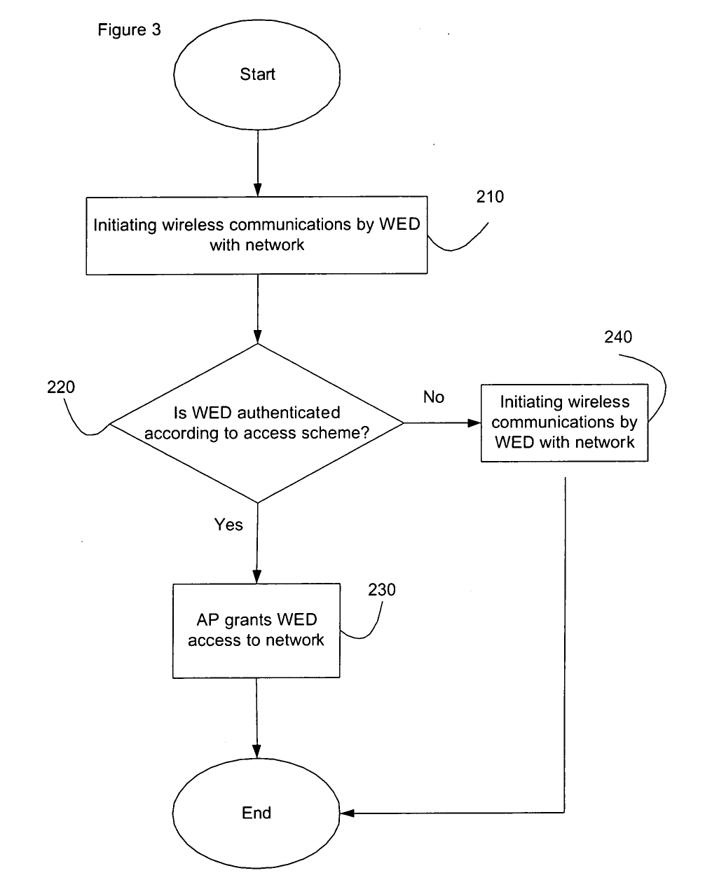

FIG. 3 shows an exemplary embodiment of a method according to the present invention for authorized communications between the WED and the AP 30. In step 210, the user initiates a wireless access to the network 12 by sending wireless signals from WED to the AP 30. If the WED and the AP 30 had a previous direct/indirect contact, then these devices are part of the access scheme and should act according to the access scheme. For example, the wireless signals of the WED which are sent to the AP 30 include the unique identifier and/or a device identifier.

In step 220, the AP 30 determines if the wireless signal was sent from an authorized WED (i.e., an authentication procedure is initiated according to the access scheme). For example, the AP 30 may compare the unique identifier included in the wireless signal to the unique identifier stored in its memory. If the two unique identifiers are identical, the authentication procedure is successful and the WED has been authenticated and is authorized to access the network 12 (step 230). As described above, the authentication procedure may proceed according to the predefined procedure of the access scheme. For example, a set of random number is exchanged between the WED and the AP 30 on a periodic basis. Alternatively, based on the predefined procedure, each of the WED and the AP 30 may separately generate at least one authentication number. The authentication numbers, although generated separately by the devices and not previously exchanged, should match because they were generated according to the same predefined procedure.

Once the WED is granted access to the network 12, the WED may access assets of the network 12 and/or access to the further network 35. Otherwise, the authentication procedure is unsuccessful and the WED is not granted access to the network 12 (step 240).

In an alternative exemplary embodiment of the present invention, the AP 30 may provide the user with an indication (e.g., blinking LEDs, a sound alarm, etc.) that the authentication process was completed successfully or not.

Those skilled in the art would understand that the access scheme may define the authentication procedure. For example, the access scheme may require that the unique identifier is attached to each transmission from the WED to the AP 30. Alternatively, the unique identifier may be only provided upon a request by the AP 30 or at a predetermined time (e.g., every 4 hours the computing device 10 must be authenticated).

In an alternative exemplary embodiment of the present invention, the AP 30 may send/record a warning to the further network 35 and/or a previously authenticated WED that an unauthenticated WED was trying to access the network 12. As would be understood by those skilled in the art, the warning may be a marking on a network log, an email to a network administrator and/or a suspension in network activities until the warning is removed by verification that the network 12 is not compromised and is secure.

In another alternative exemplary embodiment of the present invention, the authentication of the WED may only occur within a predetermined time period (e.g., 60 seconds). For example, the user may press a button on the AP 30 which begins a count of a timer period when the authentication process as described above must be completed. Thus, the user has until the counter reaches the end of the predetermined time period to complete the authentication procedure (e.g., to send the wireless signal to the AP 30). Furthermore, those skilled in the art would understand that the button on the AP 30 may be replaced by any mechanical/electronic activator such as a switch, dial, dip switch, etc. Alternatively, the timer period of the AP 30 may be activated remotely.

If the user was unable to complete the authentication process within the set time period, the user having the physical access to the AP 30, may press the button again, thus initiating another time period for the authentication process.

In an alternative exemplary embodiment, a controlled location which is accessible only by the authorized user may have the barcode or the RFID tag. The controlled location may be a locked room, an area under surveillance, a safe, etc. The user may access the location and scan the barcode/RFID with a barcode scanner on the WED or the WCA. The barcode may, for example, contain an authentication code or an encryption key that have been previously stored in the memory of the AP 30. Thus, the user can access the network 12 because the AP 30 identify the authentication code as one that is prestored in its memory.

The present invention has been described with the reference to the computing device 10, the AP 30 and the network 12. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

1. An access point, comprising:
a memory storing an access scheme which defines an authentication procedure for allowing the wireless communications between a wireless electronic device and a further asset, the authentication procedure utilizing data as defined by the access scheme; and
a processor capable of performing the authentication procedure,
wherein the access point allows the wireless communications between the device and the further asset only when the authentication procedure is successful, and
wherein before the authentication procedure, the data is transferred between the device and the access point via a physical access to at least one of the access point and the device.

2. The access point according to claim 1, wherein the access scheme includes a unique identifier for at least one of the device and a wireless communication arrangement of the device matches a further unique identifier, the further unique identifier being stored in the memory during the physical access.

3. The access point according to claim 1, wherein the further asset is one of a wide area network and the Internet.

4. The access point according to claim 1, wherein the device includes at least one of a desktop computer, a printer, a laptop, a server, a mobile computing unit, a PDA, a cell phone, a VOIP phone, and a two-way pager.

5. The access point according to claim 2, wherein the access point is situated in a location accessible only to an authorized user and wherein the memory includes a software for storing the unique identifier.

6. The access point according to claim 5, wherein the software permits storing the unique identifier into the memory only when there is a direct contact with the access point at the location.

7. The access point according to claim 5, wherein the software does not permit storing the unique identifier wirelessly.

8. The access point according to claim 5, wherein the software does not permit storing the unique identifier from an area located outside of the location.

9. The access point according to claim 2, wherein the device is a mobile computing device including a wireless removable radio card, the radio card being inserted into a slot of the access point to provide of the unique identifier.

10. The access point according to claim 2, wherein the device is connected using a wire with the access point to provide the unique identifier.

11. The access point according to claim 2, wherein the device stores the unique identifier onto a portable memory device, the memory device being connected to the access point to provide the unique identifier.

12. The access point according to claim 11, wherein the portable memory device is one a compact flash card, a secure digital card and a memory stick.

13. The access point according to claim 2, further comprising:
an input arrangement removably attached to the access point,
wherein the unique identifier is one of provided and removed to/from the memory via the input arrangement.

14. The access point according to claim 13, wherein the input arrangement includes at least one of a barcode reader, an RFID reader, a keypad and a keyboard.

15. The access point according to claim 14, wherein the unique identifier is stored as a barcode, the unique identifier being provided to the access point by reading the barcode using the barcode reader.

16. The access point according to claim 14, wherein the unique identifier is stored as an RFID tag, the unique identifier being provided to the access point by the RFID tag using the RFID reader.

17. The access point according to claim 2, wherein the unique identifier is generated as a function of a serial number of the device, an identifier of the device's manufacturer, and a preprogrammed number.

18. The access point according to claim 2, wherein the unique identifier is encrypted during the wireless communication of the device with the access point.

19. The access point according to claim 2, further comprising:
an output arrangement activating when there is a match of the unique identifier.

20. The access point according to claim 19, wherein the output arrangement includes at least one of an LED and a sound device.

21. The access point according to claim 1, wherein the access scheme periodically requests performance of the authentication procedure to further allow the wireless communications.

22. The access point according to claim 1, wherein when the authentication procedure is unsuccessful, the access scheme executes an alarm procedure.

23. A system, comprising:
an electronic device including a wireless communication arrangement; and
a wireless access point including a memory and capable of wirelessly communicating with the device, the memory storing an access scheme which defines an authentication procedure for allowing the wireless communications between the device and a further asset, the authentication procedure utilizing data as defined by the access scheme,
wherein the access point allows the wireless communications between the device and the further asset only when the authentication procedure is successful, and
wherein before the authentication procedure, the data is transferred between the device and the access point via a physical access to at least one of the access point and the device.

24. The system according to claim 23, wherein the access scheme includes a unique identifier of at least one of the device and the wireless communication arrangement of the device matches a further unique identifier, the further unique identifier being stored in the memory during the physical access.

25. The system according to claim 24, wherein the access point is situated in a location accessible only to an authorized user and wherein the memory includes a software for storing the unique identifier.

26. The system according to claim 25, wherein the software permits storing the unique identifier into the memory only when there is a direct contact with the access point at the location.

27. The system according to claim 24, wherein the device is a mobile computing device including a wireless removable radio card, the radio card being inserted into a slot of the access point to provide of the unique identifier.

28. The system according to claim 24, wherein the device includes an input arrangement removably attached to the access point, the unique identifier being one of provided and removed to/from the memory via the input arrangement.

29. The system according to claim 28, wherein the unique identifier is stored as a barcode, the unique identifier being provided to the access point by reading the barcode using the barcode reader.

30. The system according to claim 28, wherein the unique identifier is stored as an RFID tag, the unique identifier being provided to the access point by the RFID tag using the RFID reader.

31. The system according to claim 24, wherein the access scheme periodically requests performance of the authentication procedure to further allow the wireless communications.

32. A method, comprising the steps of:
transferring data between a wireless electronic device and a wireless access point via a physical access to at least one of the access point and the device, the access point including a memory storing an access scheme which defines an authentication procedure for allowing the wireless communications between the device and a further asset, the authentication procedure utilizing the data as defined by the access scheme; and
allowing by the access point the wireless communications between the device and the further asset only when the authentication procedure is successful.

33. The method according to claim 32, wherein the access scheme includes a unique identifier of at least one of the device and a wireless communication arrangement of the device matches a further unique identifier, the further unique identifier being stored in the memory during the physical access.

34. The method according to claim 33, wherein the access point is situated in a location accessible only to an authorized user and wherein the memory includes a software for storing the unique identifier.

35. The method according to claim 34, wherein the software permits storing the unique identifier into the memory only when there is a direct contact with the access point at the location.

36. The method according to claim 33, wherein the device is a mobile computing device including a wireless removable radio card, the method further comprising the step of:
inserting the radio card into a slot of the access point to provide of the unique identifier.

37. The method according to claim 33, wherein the device includes an input arrangement removably attached to the access point, the method further comprising the step of:
providing the identifier to the memory via the input arrangement.

38. The method according to claim 37, wherein the unique identifier is stored as a barcode and the input arrangement includes a barcode reader, the method further comprising the step of:
reading the barcode using the barcode reader to obtain the unique identifier.

39. The method according to claim 37, wherein the unique identifier is stored as an RFID tag and the input arrangement includes an RFID reader, the method further comprising the step of:
reading the RFID tag using the RFID reader to obtain the unique identifier.

40. The method according to claim 32, wherein the access scheme periodically requests performance of the authentication procedure to further allow the wireless communications.
